(19) United States
(12) Patent Application Publication
(10) Pub. No.: US 2018/0142567 A1
(43) Pub. Date: May 24, 2018

(54) SEALING SYSTEM FOR AN AXIAL TURBOMACHINE AND AXIAL TURBOMACHINE

(71) Applicant: MTU Aero Engines AG, Munich (DE)

(72) Inventor: Hermann Klingels, Dachau (DE)

(73) Assignee: MTU Aero Engines AG, Munich (DE)

(21) Appl. No.: 15/815,494

(22) Filed: Nov. 16, 2017

(30) Foreign Application Priority Data
Nov. 18, 2016 (DE) 10 2016 222 720.3

(51) Int. Cl. F01D 11/20; F01D 11/12; F01D 5/22; F01D 5/28

(52) U.S. Cl. CPC F01D 11/20; F01D 11/127; F05D 2240/55; F01D 5/288; F05D 2260/941; F01D 5/225

(57) ABSTRACT

The present invention relates to a sealing system for an axial turbomachine for a gas turbine, including a rotor with a radially outward arranged shroud and a housing that surrounds the rotor, wherein a gap is arranged between the shroud and the housing, and wherein the gap is bounded by a seal, which is joined to the housing, and at least one sealing tip arranged at the shroud opposite to the seal, for reducing the flow losses through the gap. At the downstream end region of the seal, another static sealing tip, which is joined to the housing, is arranged for influencing the flow through the gap and/or for influencing the flow downstream of the static sealing tip. The present invention further relates to an axial turbomachine with at least one low-pressure turbine stage, wherein the low-pressure turbine stage comprises a sealing system according to the invention.

### BACKGROUND OF THE INVENTION

The present invention relates to a sealing system for an axial turbomachine. The present invention further relates to an axial turbomachine.

In axial turbomachines, in particular in multistage axial turbomachines, the pressure of the operating medium (or conveyed medium) changes from stage to stage. In a turbomachine designed as a gas turbine, the pressure in the compressor is, as a rule, higher downstream of a row of blades or vanes than the pressure upstream; in the turbine, in contrast, the pressure is lower downstream than the pressure upstream. In order to achieve a high efficiency of the turbomachine, it is necessary for the operating medium to be conveyed through the blading of the individual stages and not to circumvent the row of blades or vanes as a leakage flow (or bypass flow) without output of work. For this purpose, a sealing system, which is designed as a labyrinth system, for example, is provided in the region of an outer boundary of an annular space.

Sealing systems of this kind have the task of minimizing a leakage flow through a sealing gap between the rotating blading and a housing and hence to enable a stable operating behavior at high efficiency. Usually, the rotating components of a turbine have sealing fins or sealing tips, which can graze or run in against honeycomb seals. In this case, the seals are designed as abradable and run-in coatings. Through minimization of the radial gaps above the sealing fins, it is attempted to minimize the leakage flows through the cavities into these regions, in particular into regions above shrouds of rotating blades, and the losses in efficiency that thereby ensue. Nonetheless, when leakage flows enter into the so-called main flow of the turbomachine, mixing losses result due to different directions and speeds of the main flow and leakage flow.

### SUMMARY OF THE INVENTION

An object of the present invention is to provide a sealing system for an axial turbomachine. Furthermore, it is an object of the present invention to provide an axial turbomachine having the sealing system according to the present invention.

The object in accordance with the invention is achieved by a sealing system in accordance with the present invention. It is further solved by an axial turbomachine with the features of the present invention.

Proposed in accordance with the invention is accordingly a sealing system for an axial turbomachine, wherein the sealing system comprises at least one rotor with a shroud arranged radially outside and a housing surrounding the rotor. A gap is arranged between the shroud and the housing. The gap is bounded, on one side, by a seal that is joined to the housing and, on the other side, by at least one sealing tip that is arranged at the shroud. This sealing tip arranged at the shroud may be referred to as a rotating sealing tip, because it rotates together with the rotor. The seal, as viewed in the radial direction, is arranged opposite to the shroud. The bounding of the gap by way of the seal and the shroud can reduce the flow losses of the gap flow. Arranged at the downstream end region of the housing-side seal is another static sealing tip that is joined to the housing. By this static sealing tip, the flow through the gap is influenced and, in particular, is reduced. Alternatively or additionally, the flow downstream of the static sealing tip is influenced by the static sealing tip.

An influence on and, in particular, a reduction of the flow through the gap by the static sealing tip can be caused by flow losses of the static sealing tip.

Alternatively or additionally, it is possible for the static sealing tip to influence any potential eddy formation downstream of the static sealing tip. The gap flow between the static sealing tip and the shroud can bring about or cause an eddy or an eddy region downstream, the direction of rotation of which primarily has the same direction of flow as the adjacent main flow. In this way, it is possible to reduce the flow losses and/or the disruption of the main flow due to this eddy. This can advantageously increase the efficiency of the axial turbomachine by way of the sealing system according to the invention.

A reduction in the disruption of the main flow due to the described direction of rotation of the eddy may be referred to as a low-loss mixing with the main flow. In contrast to this, a sealing system without a static sealing tip can lead to an eddy formation, the primary direction of rotation of which is opposite to the main flow. This would lead to a high-loss mixing with the main flow and could contribute to a reduction in the efficiency of the turbomachine.

The radially outer shroud arranged at the rotor may be referred to as an outer shroud or as a rotating blade outer shroud.

The gap arranged between the shroud and the housing may be referred to as a rotor gap.

The axial turbomachine according to the invention comprises at least one low-pressure turbine stage with a sealing system according to the invention. In addition, the axial turbomachine can have at least one high-pressure turbine stage, one low-pressure compressor stage, and one high-pressure compressor stage. Each of the mentioned stages can have a sealing system according to the invention.

The axial turbomachine can be a gas turbine, in particular an aircraft gas turbine or an aircraft engine.

Advantageous enhancements of the present invention are each the subject matter of dependent claims and embodiments.

Exemplary embodiments in accordance with the invention can have one or more of the features mentioned below.

A static and/or a rotating sealing tip may be referred to as a sealing fin.

In some exemplary embodiments according to the invention, the seal, which is joined to the housing, can be a run-in seal. A run-in seal may be referred to as an abradable seal. A run-in seal can have a run-in coating or a run-in layer, into which, for example, a sealing tip can penetrate for creation of a sealing gap. This sealing gap can be designed to be small through the penetration or run-in of a sealing tip, in particular during a provided operating state, and is thus advantageous for optimizing the efficiency of the turbomachine. The run-in seal can comprise a honeycomb structure for penetration of a sealing tip.

The run-in seal can be joined to the housing in a material-bonded manner and/or in a form-fitting manner. The run-in seal can be adhesively attached, soldered, riveted, or clamped, or fastened in a different way to the housing.

In some exemplary embodiments in accordance with the invention, the run-in seal is fastened only to the housing. In this embodiment, no run-in seal is fastened to the rotor, in particular to the shroud of the rotor. Accordingly, the run-in seal is arranged only on one side of the gap.

In some exemplary embodiments in accordance with the invention, the shroud can have at least two sealing tips. Two sealing tips can engage in two opposite-lying run-in seals at the housing and form a sealing gap. The at least two sealing tips can be arranged axially in succession on a radius or at a height radially. Alternatively, the two sealing tips can be arranged in succession axially at different radii or at radially different heights, that is, radially offset.

In some exemplary embodiments in accordance with the invention, the shroud has no seal and, in particular, no run-in seal.

In some exemplary embodiments in accordance with the invention, the shroud has three or more sealing tips. The sealing tips can be arranged radially at one height or at different heights. For example, two sealing tips that are arranged axially in succession can have the same radius, whereas a third sealing tip is radially arranged further outward.

In some exemplary embodiments in accordance with the invention, the at least one sealing tip of the shroud is arranged upstream at a tilt. The angle of tilt between the radial direction and the axial direction can be, for example, at least 15 degrees. The angle of a sealing tip that is not tilted in the radial direction would be zero degrees. A tilted sealing tip can influence advantageously the flow losses due to a smaller flow through the gap. A tilted sealing tip can also be advantageous in terms of the shroud configuration—for example, in the case of an arrangement of a plurality of sealing tips at the shroud. Likewise, the structural strength of the shroud can advantageously be greater with a tilted sealing tip. In particular, the frontmost upstream sealing tip of the shroud can be tilted. The tilt can be twenty degrees, twenty-five degrees, thirty degrees, or more.

In some exemplary embodiments in accordance with the invention, the shroud has a wear protection in the opposite-lying region of the static sealing tip. The wear protection can advantageously prevent any direct contact of the static sealing tip with the base material of the shroud. A direct contact could damage the shroud and hence cause major damage.

In some exemplary embodiments in accordance with the invention, the wear protection of the shroud extends over the opposite-lying region of the static sealing tip, in particular at least to the adjoining end of the shroud. The wear protection can extend over additional regions of the shroud.

In some exemplary embodiments in accordance with the invention, the wear protection is a coating, at least in sections, of the shroud. Alternatively, however, the wear protection layer can also be understood to mean a lamellar element that is fastened at the shroud in a material-bonded or force-fitting manner, such as, for example, an element made of a material with the trade name “Stellit.”

In some exemplary embodiments in accordance with the invention, the wear protection is arranged in regions over the periphery of the shroud. For example, the wear protection can be arranged at individual points of the shroud.

In some exemplary embodiments in accordance with the invention, the material of the static sealing tip has a lesser hardness in comparison to the hardness of the wear protection layer. The hardness of the material can be a measure of the resistance of the material to wear. The material of the wear protection layer preferably differs from the base material of the shroud and, in particular, likewise has a greater hardness in comparison to this base material. The term “greater hardness” in terms of the present invention means, in particular, a “greater wear resistance.”

In some exemplary embodiments in accordance with the invention, the wear protection is elevated in comparison to the remaining shroud surface or, in other words, the wear protection extends outward in its height above the surface. The wear protection thickness can be, for example, 5 μm, 10 μm, 20 μm, or another thickness.

In some exemplary embodiments in accordance with the invention, a wear protection is produced by a local edge layer hardening, in particular by a laser-assisted method.

In some exemplary embodiments in accordance with the invention, the static sealing tip is fastened with a form-fitting component, in particular a retaining element, at the housing. The static sealing tip can be joined to the retaining element in a material-bonded manner.

In some exemplary embodiments in accordance with the invention, the static sealing tip is fastened to the housing with a form-fitting component, in particular a retaining element, at the downstream guide vane assembly or at the connection to the guide vane assembly. The static sealing tip can be joined to the retaining element in a material-bonded manner.

In some exemplary embodiments in accordance with the invention, the rotor is a turbine rotor, in particular a low-pressure turbine rotor.

In some exemplary embodiments in accordance with the invention, the shroud is segmented over the periphery of the rotor. In particular, the segments are designed as Z-shroud segments. By Z-shroud segments, the rotating blades can be tensioned advantageously with respect to one another.

In some exemplary embodiments in accordance with the invention, the contact regions of the shroud segments have a wear protection in the peripheral direction. This wear protection can be designed as a wear protection in the opposite-lying region of the static sealing tip. In particular, this wear protection projects outward as a wear protection layer over the shroud surface, so that, in the event of a contact of the static sealing tip with the shroud, initially only the wear protection layer is touched. In particular, the hardness of the wear protection layer is greater than the hardness of the static sealing tip. As a result of this, the shroud can be protected advantageously against any contact with the static sealing tip. Such a contact could damage the shroud.

The wear protection can be joined to the shroud in a material-bonded manner, for example by welding (for example, by laser deposition welding). The material of the wear protection can be a hard alloy based on cobalt, such as, for example, a cobalt-chromium alloy, or can comprise such an alloy. The hardness of the wear protection layer can be, purely by way of example, greater than 600 Vickers hardness units (abbreviated HV).

In some exemplary embodiments in accordance with the invention, the static sealing tip is joined to the housing by a retainer element in a form-fitting and/or material-bonded manner.

In some exemplary embodiments in accordance with the invention, the static sealing tip has a variable and, in particular, wavy structure in the peripheral direction at the side lying opposite to the shroud. By the variable or wavy structure, an axially larger region of a contact surface of the sealing tip can be utilized, when the sealing tip contacts the shroud or when there is a wear protection layer on the shroud, in comparison to a non-variable or non-wavy, that is, straight structure over the periphery. By an axially larger region of the contact surface, it is advantageously possible during a contact process or a frictional process to distribute the heat input between the sealing tip and the shroud (or the wear protection layer) over a larger surface area and a greater material volume. In this way, it is possible to reduce the load locally, in particular, the thermal material load, of the wear protection layer.

Many or all of the embodiments in accordance with the invention can have one, a plurality of, or all of the advantages mentioned above and/or below.

By the sealing system according to the invention, it is possible advantageously to reduce the leakage, that is, the bypass flow or the gap flow. The leakage may be referred to as primary losses. In particular, it is possible by the static sealing tip to reduce the gap flow.

Furthermore, it is possible by the sealing system according to the invention to disrupt the main flow to a lesser extent and thus to increase the efficiency of the turbomachine. The disruptions of the main flow may be referred to as secondary losses. In particular, the eddy formation downstream of the static sealing tip can be influenced and hence the direction of rotation of an eddy can be matched to the main flow direction. In this way, it is possible to achieve a low-loss mixing of the eddies, which result from the gap flow, with the main flow.

### BRIEF DESCRIPTION OF THE DRAWING FIGURES

The present invention will be explained below by way of example on the basis of the appended drawings, in which identical reference characters indicate identical or similar components. In the respective, highly schematically simplified figures:

FIG. 1 shows a sealing system, known from the prior art, of a turbine stage, having a run-in seal and two rotating sealing tips in longitudinal section;

FIG. 2 shows a sealing system, in accordance with the invention, of a turbine stage, having a run-in seal, two rotating sealing tips, and a static sealing tip joined to the housing in longitudinal section;

FIG. 3 shows the sealing system according to the invention in a cross-sectional plane, having a static sealing tip, a rotor with a shroud, and a wear protection layer between two shroud segments;

FIG. 4 shows the shroud in a view from radially outward, with two wear protection layers; and

FIGS. 5a and 5b show two different profiles of an inner edge of the static sealing tip in the peripheral direction.

### DESCRIPTION OF THE INVENTION

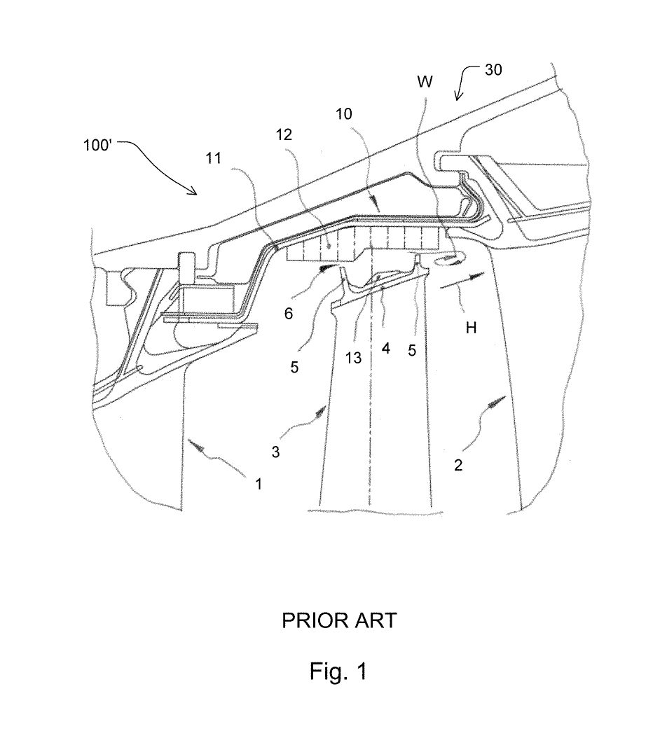

FIG. 1 shows a sealing system 100′, known from the prior art, of a turbine stage, having a run-in seal 12 and two revolving (rotating) sealing tips 5 in longitudinal section. A sealing system 100′ may be referred to synonymously as a seal system. The run-in seal 12 may be referred to as a run-in coating.

Illustrated between an upstream guide wheel or stator 1 and a downstream guide wheel or stator 2 on the housing side is a housing section 10, in which a seal carrier 11 is mounted. The housing section 10 could be referred to as a static seal part. The run-in seal 12 is fastened at the seal carrier 11, for example, in a material-bonded manner by soldering or adhesive attachment. Two sealing tips 5, which may be referred to as sealing fins, engage in the run-in seal 12. A rotor gap 6 between the run-in seal 12 and the sealing tips 5 is created or generated by running-in or cutting-in of the sealing tips 5. The sealing tips 5 are arranged at a radially outer shroud 4, which, in turn, is joined to a rotating blade 3. The shroud 4 can be joined integrally to the rotating blade 3, for example by a laser sintering production process.

The direction of flow of a leakage flow (the leakage flow may be referred to as a gap flow or as a bypass flow) is indicated by the arrow for the reference numeral of the rotor gap 6. In a turbine stage illustrated here, the pressure of the flow medium decreases in the flow-through direction of the main flow H, that is, in FIG. 1, from left to right. Consequently, the pressure upstream of the rotating blade 3 is higher in comparison to the pressure downstream of the rotating blade 3. Accordingly, the direction of flow runs in the direction of the arrow of the reference numeral of the rotor gap 6.

Downstream of the second sealing tip 5 (right in FIG. 1), the leakage flow forms an eddy W. At the site of mixing with the main flow H, high mixing losses occur, because the direction of rotation of the eddy W results in a flow with a through-flow direction that is opposite to the main flow H.

Furthermore, a reinforcement structure 13 on the shroud 4 is illustrated optionally.

The rotating blade 3 is clearly positioned opposite to the run-in seal 12 and hence opposite to the surrounding housing 30 and the guide wheels 1, 2, which may be referred to as stators. However, the rotor (not illustrated in FIG. 1) that is joined to the rotating blade or rotor 3 can move axially within certain limits in relation to the stator, for example, due to a play of the bearings, thermal expansions, and other factors. On account of these axial movements of the rotor and of the rotating blade 3, it is possible for only a few sealing tips 5 to be arranged at the shroud 4. In the exemplary embodiment of FIG. 1, two sealing tips 5 are arranged by way of example. On account of this limited number of sealing tips 5, the sealing effect is limited depending on the rotor gap 6.

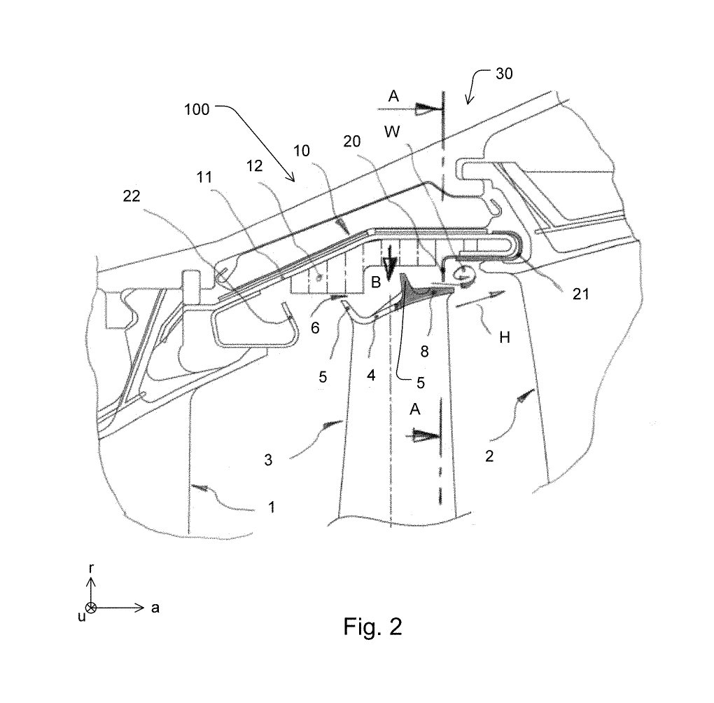

FIG. 2 shows a sealing system 100, in accordance with the invention, of a turbine stage, with an in-run seal 12, two rotating sealing tips 5, and a static sealing tip 20 joined to a housing 30 in longitudinal section.

The arrangement of the upstream guide wheel or stator 1, the downstream guide wheel or stator 2, the rotating blade 3, the housing section 10, and the seal carrier 11 (which is designed differently in FIG. 2 than in FIG. 1) is analogous to the description of FIG. 1. The two rotating sealing tips 5 are arranged on the shroud 5 axially offset in comparison to the arrangement of FIG. 1. In addition, a housing-side, static sealing tip 20 is installed opposite to the downstream end region of the shroud 4. In the exemplary embodiment of FIG. 2, the static sealing tip 20 is fixed in place by a retaining element 21 at the static housing section 10 and at the housing-side retainer of the downstream guide wheel or stator 2. The fixation can be designed as a clamping. An additional material-bonded fixation of the static sealing tip 20 at the retaining element 21 and/or of the retaining element 21 at the housing section 10 is optionally possible by a soldered or welded joint, for example.

Furthermore, a so-called baffle 22 is incorporated in the housing 30 on the inside. The baffle 22 can contribute, for example, to reducing flow losses.

The additional static sealing tip 20 can advantageously reduce the leakage resulting from the rotor gap 6. Furthermore, the direction of rotation of the eddy W forming downstream of the static sealing tip 20 with respect to the direction of rotation of the sealing system 100′ from FIG. 1 can reverse, so that a low-loss mixing with the main stream H is advantageously possible. The low-loss mixing with the main stream H is shown in FIG. 2 by the same parallel flow direction of the main flow H with the flow direction of the directly issuing eddy. As a result of these two effects of the static sealing tip 20, namely, a reduction of the leakage and a low-loss mixing of the eddy W with the main flow H, the overall losses of the turbine stage can be advantageously reduced.

The static sealing tip 20 forms, together with the rear section of the shroud 4, a sealing point that is additional to the two sealing points formed by the sealing tips 5 and the run-in seal 12.

The front, upstream sealing tip 5 is tilted, in relation to the radial direction r, opposite to the main flow direction, which is aligned in the axial direction. The tilt is about 30 degrees. By a tilted sealing tip 5, it is possible, for example, to influence the leakage flow through the rotor gap 6.

The two sealing tips 5 are arranged radially offset and hence form approximatively the widening flow channel of the turbine stage.

The shroud 4 is designed in segments over the periphery u. The segments are often designed as so-called Z shrouds (see FIG. 4, which is illustrated as view B from FIG. 2), because their peripheral edges are not formed straight in the axial direction of the turbomachine, but are rather essentially Z-shaped. By this Z shape, it is possible, in the mounted state, to tension adjacent rotating blades 3 of a rotor stage with respect to one another in the peripheral direction. FIG. 2 shows an orthogonal view onto the peripheral edge of a segment of the shroud 4. The downstream half of this peripheral edge is provided with a wear protection layer 8, which is illustrated darkly in FIGS. 2, 3, and 4. The wear protection layer 8 is hereby applied in the axial direction of the turbomachine not only in the central region of the Z-shaped peripheral edge of the shroud 4, in which the tensioning forces are to be transmitted essentially through contact between two rotating blades 3 at the shroud 4, which are adjacent in the peripheral direction, but also the wear protection layer 8 extends axially still further toward the rear. In particular, the wear protection layer 8 extends rearward in the axial direction of the turbomachine, at least up to the axial position of the static sealing tip 20. In the present exemplary embodiment, the wear protection layer 8 extends even to the downstream end of the shroud 4.

In the radial direction r, the wear protection layer 8 projects over the surface of the shroud 4. This has the advantage that, when there is an undesired contact of the static sealing tip 20 with the shroud 4, for example when an aircraft equipped with the turbomachine as an engine makes a hard landing, the static sealing tips 20 do not touch the shroud 4 itself, that is, the base material of the shroud, and possibly damage it, but rather solely touch the wear protection layer 8. When the material of the wear protection layer 8 has a greater hardness than the material of the static sealing tip 20, the static sealing tip 20 is abraded or ground down by the rotating blade 3 of the rotor. The static sealing tip 20 can easily be shortened in the radial direction r, for example. In this way, any damage at the rotor 3 is prevented. A grinding down of the static sealing tip 20 by the wear protection layer 8 is, in contrast, far less critical and, in addition, the static sealing tip 20 can be replaced relatively easily and cost-effectively.

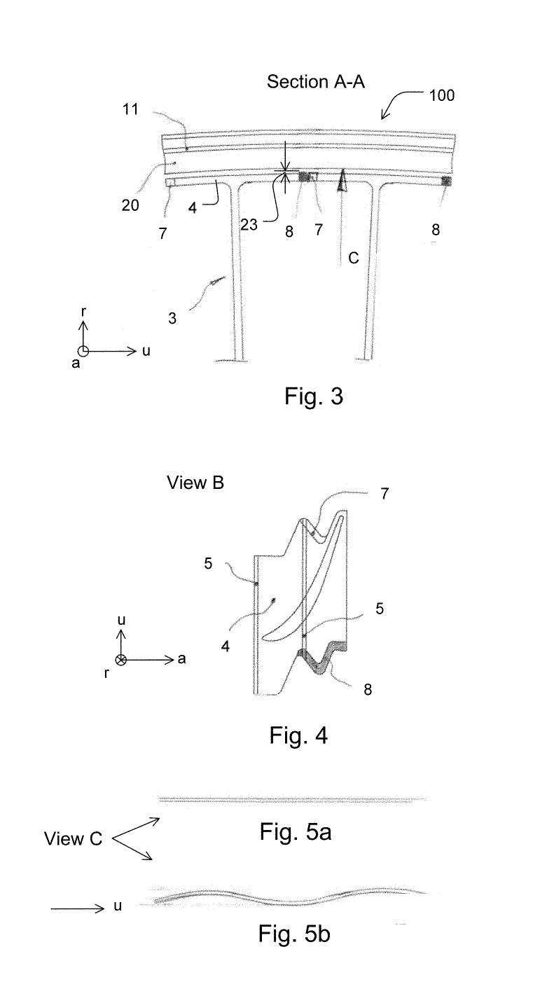

FIG. 3 shows the sealing system 100 according to the invention in a cross-sectional plane (plane A-A, see FIG. 2), with the static sealing tip 20, the seal carrier 11, the rotor 3 with the shroud 4, and a wear protection layer 8 between the shroud segments.

The shroud 4 is segmented. The so-called Z shroud has wear protection layers 7, 8 at the contact points of segments that abut one another. In particular, the wear protection layer 8, which extends further downstream in the axial direction than the wear protection layer 7, projects slightly above the radial extension of the shroud surface. This is illustrated in FIG. 3 by the shoulder height 23. On the basis of this elevation of the wear protection layer 8 above the surface of the shroud 4, the static sealing tip 20—for example, in the aforementioned case—initially touches the elevated wear protection layer 8. With a lesser hardness of the material of the static sealing tip 20 in comparison to the hardness of the material of the wear protection layer 8, the static sealing tip 20 is ground down or deformed, without, however, coming into contact with the shroud 4 itself and causing damage to it. In other words, it is possible here in a synergistic way to utilize the wear protection layer 8, which is used for the contact of two shrouds 4 that are adjacent in the peripheral direction, in order to prevent any possible damage of the base material of the shroud 4 due to a contact with the static sealing tip 20. For this purpose, the wear protection layer 8 is dimensioned only slightly larger in the axial and radial direction of the turbomachine than would otherwise be the case.

FIG. 4 shows the shroud 4 in a view B from radially outward (see FIG. 2) with the wear protection layers 7, 8. The profile form of the rotating blade shape of the rotor 3 is indicated schematically below the shroud.

The sealing tips 5 of the shroud 4 project out of the plane of the illustration. The wear protection layers 7, 8 are located at the contact surfaces of the Z shroud to the segments of additional blade shrouds (not illustrated) that are adjoined in the peripheral direction. The shadowed illustrated wear protection layer 8 was already shown in the sectional plane of FIG. 2 opposite to the static sealing tip 20.

FIG. 5a, b shows two different profiles of the radially inner edge or the inner edge of the static sealing tip 20 in the peripheral direction u in a view C (see FIG. 3). Illustrated in FIG. 5a is a straight profile form and illustrated in FIG. 5b is a wavy form. The wavy form offers the advantage that, in the case of contact of the static sealing tip 20 with the wear protection layer 8 of the shroud 4, an axially larger region of the wear protection layer 8 can be utilized for a grinding down or a deforming of the static sealing tip 20. In this way, when there is a contact of the static sealing tip 4 with the wear protection layer 8, the heat input is distributed over a greater material volume, as a result of which the wear protection layer 8 is subject locally to a reduced load.

It would be appreciated by those skilled in the art that various changes and modifications can be made to the illustrated embodiments without departing from the spirit of the present invention. All such modifications and changes are intended to be covered by the appended claims.

What is claimed is:

1. A sealing system for a gas turbine, comprising:
a rotor with a radially outward arranged shroud and a housing that surrounds the rotor, wherein a gap is arranged between the shroud and the housing and wherein the gap is bounded by a seal, which is joined to the housing, and at least one sealing tip arranged at the shroud opposite to the seal, for reducing the flow losses through the gap;
at the downstream end region of the seal, another static sealing tip, which is joined to the housing, is configured and arranged for influencing the flow through the gap and/or for influencing the flow downstream of the static sealing tip.

2. The sealing system according to claim 1, wherein the seal is a run-in seal.

3. The sealing system according to claim 1, wherein the shroud has at least two sealing tips.

4. The sealing system according to claim 1, wherein the at least one sealing tip of the shroud is tilted on the upstream side.

5. The sealing system according to claim 4, wherein the angle between the radial direction and the axial direction is at least 15 degrees.

6. The sealing system according to claim 1, wherein the shroud has a wear protection layer in the region of the static sealing tip that lies opposite in the radial direction.

7. The sealing system according to claim 6, wherein the wear protection layer is a coating of the shroud.

8. The sealing system according to claim 6, wherein the material of the static sealing tip has a lesser hardness in comparison to the hardness of the wear protection layer.

9. The sealing system according to claim 1, wherein the rotor is a low-pressure turbine rotor.

10. The sealing system according to claim 1, wherein the shroud is segmented into segments over the periphery of the rotor.

11. The sealing system according to claim 10, wherein contact regions of the segments have the wear protection in the peripheral direction.

12. The sealing system according to claim 1, wherein the static sealing tip is joined to the housing by a retaining element in a form-fitting manner and/or material-bonded manner.

13. The sealing system according to claim 1, wherein the static sealing tip has a wavy structure at the side that lies opposite to the shroud in the peripheral direction.

14. The sealing system according to claim 1, wherein the sealing system is configured and arranged in a low-pressure turbine stage of a gas turbine.

15. The sealing system according to claim 1, wherein the gas turbine is an aircraft engine.

16. The sealing system according to claim 7, wherein the material of the static sealing tip has a lesser hardness in comparison to the hardness of the wear protection layer.
